(19) United States
(12) Patent Application Publication
(10) Pub. No.: US 2025/0001314 A1
(43) Pub. Date: Jan. 2, 2025

(54) VIRTUAL REALITY (VR) ENVIRONMENT BASED ON AN INDUSTRIAL FLOOR

(71) Applicant: International Business Machines Corporation, Armonk, NY (US)

(72) Inventors: Binoy Thomas, Kozhikode (IN); Sarbajit K. Rakshit, Kolkata (IN); Sudheesh S. Kairali, Kozhikode (IN)

(21) Appl. No.: 18/215,068

(22) Filed: Jun. 27, 2023

(51) Int. Cl. A63F 13/80; A63F 13/52; G06T 19/00

(52) U.S. Cl. CPC A63F 13/80; A63F 13/52; G06T 19/00; A63F 2300/8082

(57) ABSTRACT

A computer-implemented method, according to one embodiment, includes creating a virtual reality (VR) environment that is based on an industrial floor, and providing, to at least a first VR device associated with a first user and a second VR device associated with a second user, access to the VR environment. A first gamification role is assigned to the first VR device, and a second gamification role is assigned to the second VR device. The first gamification role is based on a first industrial task of the industrial floor, and the second gamification role is based on a second industrial task of the industrial floor. The method further includes receiving gamification role data from the VR devices, and determining and storing, based on the gamification role data, a specification for deploying on a physical industrial floor.

### BACKGROUND

The present disclosure relates to virtual reality (VR), and more specifically, this disclosure relates to creating a virtual reality (VR) environment that is based on an industrial floor and assigning gamification roles to users that access the VR environment. Virtual reality (VR) is a three-dimensional, computer-generated environment which can be explored and interacted with by a person. These explorations and interactions are enabled by utilizing user devices. These user devices may include, e.g., a VR headset, an augmented reality (AR) headset, VR glasses, VR rooms that include a plurality of display walls, etc. Within a shared virtual world, users are able to interact with other users, e.g., virtually meet, converse, perform virtual activities, collaborate, etc. Furthermore, users of the user devices are able to temporarily become part of a virtual world, and whilst there, are able to manipulate objects and/or perform a series of actions.

### SUMMARY

A computer-implemented method, according to one embodiment, includes creating a virtual reality (VR) environment that is based on an industrial floor, and providing, to at least a first VR device associated with a first user and a second VR device associated with a second user, access to the VR environment. A first gamification role is assigned to the first VR device, and a second gamification role is assigned to the second VR device. The first gamification role is based on a first industrial task of the industrial floor, and the second gamification role is based on a second industrial task of the industrial floor. The method further includes receiving gamification role data from the VR devices, and determining and storing, based on the gamification role data, a specification for deploying in a physical industrial floor.

A computer program product, according to another embodiment, includes a computer readable storage medium having program instructions embodied therewith. The program instructions are readable and/or executable by a computer to cause the computer to perform the foregoing method.

A system, according to another embodiment, includes a processor, and logic integrated with the processor, executable by the processor, or integrated with and executable by the processor. The logic is configured to perform the foregoing method.

Other aspects and embodiments of the present disclosure will become apparent from the following detailed description, which, when taken in conjunction with the drawings, illustrate by way of example the principles of the disclosure.

### BRIEF DESCRIPTION OF THE DRAWINGS

FIG. 1 is a diagram of a computing environment, in accordance with one embodiment of the present disclosure.

FIG. 2 is a flowchart of a method, in accordance with one embodiment of the present disclosure.

FIGS. 3A-3E depict an environment, in accordance with several embodiments.

### DETAILED DESCRIPTION

The following description is made for the purpose of illustrating the general principles of the present disclosure and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The following description discloses several preferred embodiments of systems, methods and computer program products for creating a virtual reality (VR) environment that is based on an industrial floor and assigning gamification roles to users that access the VR environment.

In one general embodiment, a computer-implemented method includes creating a VR environment that is based on an industrial floor, and providing, to at least a first VR device associated with a first user and a second VR device associated with a second user, access to the VR environment. A first gamification role is assigned to the first VR device, and a second gamification role is assigned to the second VR device. The first gamification role is based on a first industrial task of the industrial floor, and the second gamification role is based on a second industrial task of the industrial floor. The method further includes receiving gamification role data from the VR devices, and determining and storing, based on the gamification role data, a specification for deploying in a physical industrial floor.

In another general embodiment, a computer program product includes a computer readable storage medium having program instructions embodied therewith. The program instructions are readable and/or executable by a computer to cause the computer to perform the foregoing method.

In another general embodiment, a system includes a processor, and logic integrated with the processor, executable by the processor, or integrated with and executable by the processor. The logic is configured to perform the foregoing method.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as gamification role determination code of block 150 for creating a VR environment that is based on an industrial floor and assigning gamification roles to users that access the VR environment. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

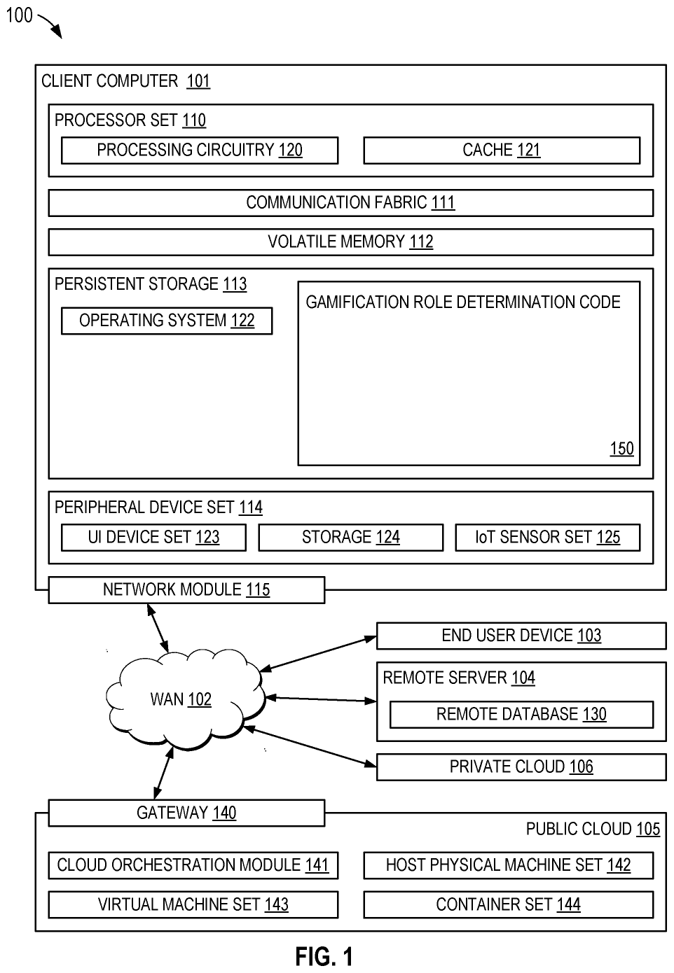

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

In some aspects, a system according to various embodiments may include a processor and logic integrated with and/or executable by the processor, the logic being configured to perform one or more of the process steps recited herein. The processor may be of any configuration as described herein, such as a discrete processor or a processing circuit that includes many components such as processing hardware, memory, I/O interfaces, etc. By integrated with, what is meant is that the processor has logic embedded therewith as hardware logic, such as an application specific integrated circuit (ASIC), a FPGA, etc. By executable by the processor, what is meant is that the logic is hardware logic; software logic such as firmware, part of an operating system, part of an application program; etc., or some combination of hardware and software logic that is accessible by the processor and configured to cause the processor to perform some functionality upon execution by the processor. Software logic may be stored on local and/or remote memory of any memory type, as known in the art. Any processor known in the art may be used, such as a software processor module and/or a hardware processor such as an ASIC, a FPGA, a central processing unit (CPU), an integrated circuit (IC), a graphics processing unit (GPU), etc.

Of course, this logic may be implemented as a method on any device and/or system or as a computer program product, according to various embodiments.

As mentioned elsewhere above, VR is a three-dimensional, computer-generated environment which can be explored and interacted with by a person. These explorations and interactions are enabled by utilizing user devices. These user devices may include, e.g., a VR headset, an augmented reality (AR) headset, VR glasses, VR rooms that include a plurality of display walls, etc. Within a shared virtual world, users are able to interact with other users, e.g., virtually meet, converse, perform virtual activities, collaborate, etc. Furthermore, users of the user devices are able to temporarily become part of a virtual world, and whilst there, are able to manipulate objects and/or perform a series of actions.

Industrial automation is the use of control systems, such as computers or robots, and information technologies for handling different processes and machineries in an industry to replace a human being. It is a second step beyond mechanization in the scope of industrialization. An early purpose of automation was to increase productivity (since automated systems can be run twenty-four hours a day) and to reduce costs. However, today, the focus of automation has shifted to increasing quality and flexibility in manufacturing processes. In the automobile industry, the installation of pistons into an engine is presently performed using automated machinery with an error rate of 0.00001%. This accuracy is not otherwise available using humans, as humans have been determined to have an error rate of 1.0-1.5% when manually installing pistons into an engine.

Industrial automation fulfills a company's aim of maximum production by allowing the company to run a manufacturing plant for twenty-four hours a day, seven days a week, and 365 days a year. This leads to a significant improvement in the productivity of the company. Automation also reduces the error associated with a human being. Accordingly, products with uniform quality are able to be manufactured regardless of the time of day.

Adding a new task in an assembly line requires training with a human operator, however, robots can be programmed to perform any task. This makes the manufacturing process more flexible. Furthermore, industrial automation enables employee safety within a production line by deploying robots to handle hazardous conditions.

One longstanding issue currently experienced within the field of industrial automation is that it is difficult to explain automation requirement(s) of any industrial floor. For example, based on the complexities associated with automated processes, humans are not able to conceptually relate, e.g., how machines should communicate with each other, how material can be moved from one machine to another machine, spatial requirements of machines of an industrial floor, etc. Accordingly, buildouts that are attempted by humans often include errors which thereby results in waste, corrections being performed, etc. Furthermore, in some cases, users associated with a buildout have to travel to a proposed buildout location in order to attempt to conceptualize a potential buildout. Accordingly, there is a longstanding need for interactive gamification techniques that enable automation requirements on an industrial floor to be realized. More specifically, there is a longstanding need for techniques that enable people across different locations to brainstorm and virtually define automation requirements of an industrial floor.

In sharp contrast to the deficiencies described above, various embodiments and approaches described herein include techniques that create a VR environment that is based on an industrial floor. VR devices are provided access to the VR environment and assigned gamification roles based on industrial tasks of the industrial floor to efficiently establish a specification for deploying on a physical industrial floor.

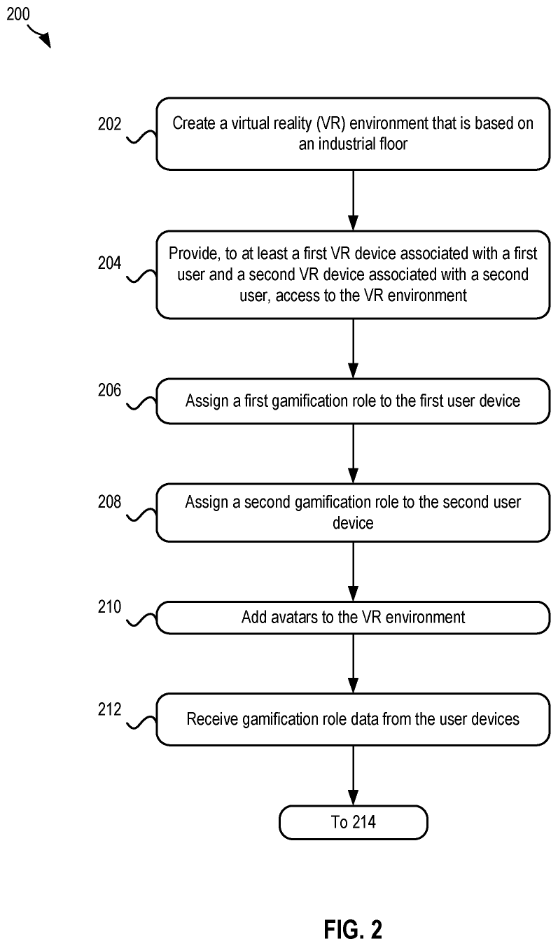

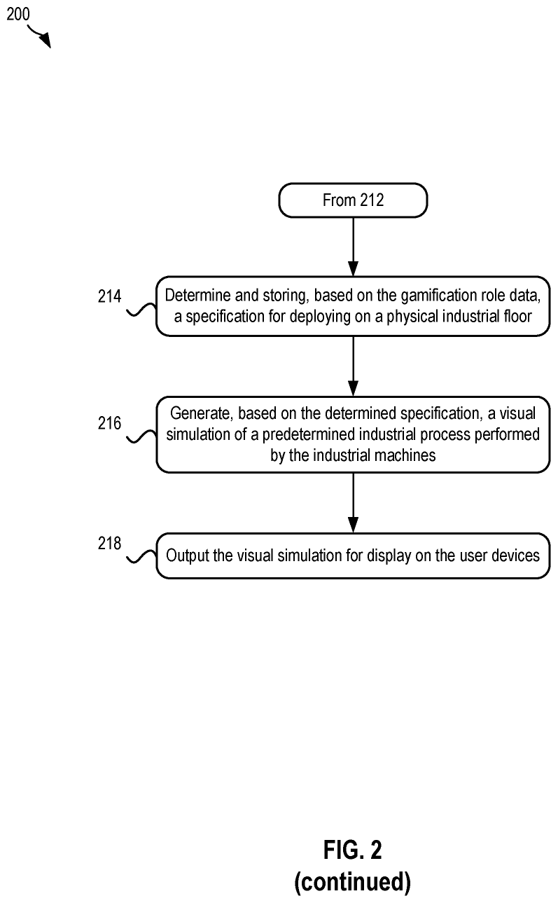

Now referring to FIG. 2, a flowchart of a method 200 is shown according to one embodiment. The method 200 may be performed in accordance with the present disclosure in any of the environments depicted in FIGS. 1-3D, among others, in various embodiments. Of course, more or fewer operations than those specifically described in FIG. 2 may be included in method 200, as would be understood by one of skill in the art upon reading the present descriptions.

Each of the steps of the method 200 may be performed by any suitable component of the operating environment. For example, in various embodiments, the method 200 may be partially or entirely performed by a computer, or some other device having one or more processors therein. The processor, e.g., processing circuit(s), chip(s), and/or module(s) implemented in hardware and/or software, and preferably having at least one hardware component, may be utilized in any device to perform one or more steps of the method 200. Illustrative processors include, but are not limited to, a central processing unit (CPU), an application specific integrated circuit (ASIC), a field programmable gate array (FPGA), etc., combinations thereof, or any other suitable computing device known in the art.

Operation 202 includes creating a VR environment that is based on an industrial floor. In some approaches, the VR environment is implemented in a trusted execution environment (TEE). Furthermore, in one or more of such approaches, the TEE may be a secure container. Techniques for creating a VR environment that is implemented in a TEE, that would become apparent to one of ordinary skill in the art after reading the descriptions herein, may be used.

The VR environment may be based on an industrial floor in that a user device that is granted access to the VR environment is provided with, e.g., output, a feed of the VR environment that depicts a known type of industrial floor. In other words, as a result of the feed being displayed on a display of the user device, a user that views the display has a perspective of being within the VR environment at the location of an industrial floor. The first communication device is, in some preferred approaches, a VR headset and/or glasses that may be configured to be worn by a human being. For example, the user devices may, in some preferred approaches, be, e.g., a pair of AR glasses including one or more AR lenses, a pair of AR contact lenses, a VR headset, etc. The user devices may additionally and/or alternatively include one or more speakers, e.g., earpieces, bone conduction headphones, audio speakers, etc., cameras, microphones, etc. Furthermore, the user devices may additionally and/or alternatively include a processing circuit with a cellular antenna that allows the user devices to communicate with one another. In some approaches, the VR environment may depict a concrete slap and/or a portion of land that may be covered, that an industrial floor with a plurality of industrial machines may be built-out on. For context, the industrial machines may include, e.g., a robotic machine, a shaping machine, a lathe machine, a conveyor belt, a transport machine, a hammering machine, a welding machine, etc. In various embodiments herein, the user devices are described to be VR devices, although one or more of the user devices may be another type of user device in some other embodiments.

In some approaches, a scale of the VR environment, e.g., dimensions of an area that the industrial floor may be virtually built-out on, may be dynamically adjusted in the VR environment based on a type and/or number of industrial machines that are being considered for incorporating in the industrial floor. For example, an industrial floor that is based on the production of agricultural tractors may be relatively larger than an industrial floor that is based on the production of bottled water. Accordingly, in some approaches, a scale of the VR may be dynamically adjusted according to and in response to a determination that an industrial process planned to be performed at a physical industrial floor based on the virtual industrial floor of the VR environment changes.

Operation 204 includes providing a plurality of VR devices, e.g., at least a first VR device associated with a first user and a second VR device associated with a second user, access to the VR environment. In some approaches, access is provided by causing an invitation, access credentials, a password, a temporary link, etc., to the VR devices. In some other approaches, at least some of the VR devices are automatically added to a group communication session that is set in the VR environment. In some other approaches, access may additionally and/or alternatively be provided to at least some of the VR devices in response to first receiving a request from such devices, and thereafter verifying that the VR devices are authorized to access the VR environment, e.g., the VR devices are listed on a dynamically determined list of authorized user devices.

Method 200 preferably includes assigning gamification roles to one or more VR devices that are granted access to the VR environment. For example, operation 206 includes assigning a first gamification role to the first VR device, and operation 208 includes assigning a second gamification role to the second VR device. The gamification roles are, in some approaches, assigned to VR devices for users associated with the VR devices to use and hold while interacting within the VR environment. In some preferred approaches, at least some of the gamification roles are based on industrial tasks of the industrial floor. For example, the first gamification role may be based on a first industrial task of the industrial floor, the second gamification role may be based on a second industrial task of the industrial floor, etc., where each of the different industrial tasks may be different from one another. For context and as previously detailed elsewhere herein, conceptualizing and discussing the specifications and development of an industrial floor and furthermore a relational interaction of an industrial process on an industrial floor is not capable of being accurately and efficiently performed by users on the phone at different physical locations. Accordingly, in some approaches herein, different industrial tasks of the industrial floor may be assigned to different VR devices to distribute different collaborative responsibilities among the different VR devices. This way, each of such VR devices may be allocated a unique time and location within the VR environment that associated users may use to discuss the build out of industrial machines that address each of the different industrial tasks. Various illustrative examples of industrial role assignments with respect to industrial tasks are detailed below.

In some approaches, the industrial task of the industrial floor may be based on a contribution that a given industrial machine has within a predetermined industrial process. For example, in some approaches, a first industrial task may be based on a first industrial machine's contribution to a predetermined industrial process within the industrial floor while the second industrial task may be based on a second industrial machine's contribution to the industrial process. In such approaches, the first industrial task and the second industrial tasks are different types of tasks. A first contextual example of a predetermined industrial process includes an assembly line production process of a product such as a car. Within this production process, a plurality of industrial machines may be assigned industrial tasks that contribute to the production of the car, e.g., a first industrial machine may be a welding machine that is assigned the industrial task of welding a plurality of metal parts together to form a frame of the car, a second industrial machine may be a conveyer machine that is assigned the industrial task of moving a plurality of car parts from a distribution portion of an industrial floor to one or more work stations, a third industrial machine may be a painting machine that is assigned the industrial task of painting a plurality of parts of the car, etc. Each of these industrial tasks contribute to the industrial process of production of the car. In another approach, a second contextual example of the predetermined industrial process includes an inspection line in which a product is inspected according to different predetermined regulations and/or standards at a plurality of different stations. Within this inspection process, a plurality of industrial machines may be assigned industrial tasks that contribute to the inspection of the product, e.g., a first industrial machine may be assigned the industrial task of inspecting whether there are any cracks in a product, a second industrial machine may be assigned the industrial task of testing the circuitry of the product, a third industrial machine may be assigned the industrial task of performing a predetermined type of scan on the product, etc. Each of these industrial tasks contribute to the industrial process of inspecting the product.

Operation 210 includes adding avatars to the VR environment. In some preferred approaches, each of the avatars is associated with a different one of the VR devices, e.g., a first avatar is added to the to the VR environment for an associated first VR device that is granted access to the VR environment, a second avatar is added to the to the VR environment for an associated second VR device that is granted access to the VR environment, a third avatar is added to the to the VR environment for an associated third VR device that is granted access to the VR environment, etc. The VR devices are, in some preferred approaches, output a viewing perspective of the VR environment that is based on an associated one of the avatars. For example, the first VR device may be associated with a first of the avatars is output and caused, e.g., instructed, to display a perspective of the VR environment that views the other avatars, e.g., the second avatar associated with the second VR device, the third avatar associated with the third VR device, etc.

One or more of the avatars may be generated based on predetermined factors. For example, in a first approach, one or more of the characters may be based on physical appearances of the associated users, e.g., a first avatar may be based on a physical appearance of a first user that uses the first VR device, a second avatar may be based on a physical appearance of a second user that uses the second VR device, etc. In some other approaches, one or more of the avatars may, depending on the approach, be cartoon based avatars that approximate the physical appearance of the participants of the VR collaboration session and/or are based on a customizable avatar profile. Moreover, each of the avatars may imitate actual physical movements that an associated one of the users makes while using the VR devices, e.g., thereby enabling the users to roleplay predicted operations of industrial machines within the VR environment. This way, each of the participants may form an impression of actually being in the VR environment with the other participants on the VR collaboration session. Because the VR environment representation may be a representation of an actual geographical location, in some approaches, the VR environment representation may additionally and/or alternatively include all or less than all of the contents, e.g., machines, obstacles, clarity, light, etc., that actually exist in the geographical location that the VR environment is based on, e.g., a planned build-out location of an industrial floor.

The predetermined factors that one or more of the generated avatars are based on may, additionally and/or alternatively, include the industrial machines of a predetermined industrial process within the industrial floor. For example, in some of such approaches, the avatars may have a semi-transparent illustration of the industrial machine that the user's character avatar is centered and visible within. This way, as a given avatar is caused to move about the VR environment, the other users viewing the VR environment gain a perspective of the size and relational orientation of one or more of the industrial machines with respect to one another. In one or more of such approaches, one of the predetermined factors that the avatars are based on, may additionally and/or alternatively include timing sequences of industrial machines of a predetermined industrial process within the industrial floor. In other words, in some approaches, an operational speed of one or more functions, e.g., a conveyor belt speed, a transitional movement speed, an output speed of a product to a next one of the industrial machines of the industrial process, etc., of a first industrial machine may be incorporated into an active feature of the avatar that is observable by other users using VR devices to view the VR environment. In some other approaches, the predetermined factors that one or more of the generated avatars are based on, may additionally and/or alternatively include spatial dimensions associated with the industrial machines. For example, in some approaches, a floor spatial contour of each industrial machine may be positioned around an animated cartoon that physically resembles the user. This way, an associated one of the VR devices may be used to position the avatar at one or more locations within the VR environment to virtually show different potential positions for the industrial machine to be located at within an actual physical build-out of the industrial floor.

As users use the VR devices to experience and interact within the VR environment, in some approaches, gamification role data may be received from one or more of the VR devices, e.g., see operation 212. In some other approaches, the gamification role data is extracted from interactions within the VR environment. For example, in one or more of such approaches, method 200 may include performing natural language processing, or one or more other data analysis techniques that would become apparent to one of ordinary skill in the art after reading the descriptions herein, may be used to distinguish nominal conversation, e.g., discussions about where to go to lunch, discussion about where the users are planning to go on vacation, etc., from conversation related to the gamification roles assigned to the VR devices, e.g., conversations about a size of an industrial machine, an orientation of a first industrial machine with respect to a second industrial machine, the speed of an industrial machine, etc. Filtering techniques and/or filter modules, that would become apparent to one of ordinary skill in the art after reading the descriptions herein, may be used to filter data associated with nominal conversation from the received gamification role data, thereby transforming the data to establish filtered gamification role data. Note that any tracking and/or analysis of user actions and conversations is preferably only performed subsequent to gaining permission from the involved users. Note that similar techniques may be applied to non-verbal actions of the users, e.g., movement, behavior, etc., in order to establish the gamification role data.

Operation 214 includes determining and storing, based on the gamification role data, a specification for deploying on a physical industrial floor. In some approaches, the determined specification may be stored on, e.g., a predetermined database, one or more of the VR devices, etc. The specification may, in some approaches, include information that details a plurality of related operational timing sequences of the industrial machines, e.g., automation requirements. Accordingly, in one or more of such approaches, each of the timing sequences may be based on a contribution of one of the industrial machines with respect to a predetermined industrial process. For example, the information may detail, e.g., a start time and a stop time, a determined conveyer belt speed, an output speed, etc.

Operation 216 includes generating, based on the determined specification, a visual simulation of a predetermined industrial process performed by the industrial machines, e.g., where the visual simulation is a virtual replica of the actual industrial floor. In some approaches, voice data collected from the received gamification role data is overlayed in the visual simulation to create a narration that details the different roles of the industrial machines, why the industrial machines are positioned in a determined configuration, how one industrial machine's output functionally relates to the input of another one of the industrial machines, etc.

The visual simulation is output for display on the VR devices and/or one or more other predetermined devices, e.g., see operation 218.

It may be noted that, subsequent to determining the specification and/or visual simulation, a size of the industrial floor at a physical location and industrial machines may change, e.g., based on budget cuts, based on an increase to an allotted budget, based on a change in locations, a size of industrial machines changing based on new industrial machines being released, etc. Accordingly, in some approaches, in response to a determination that such changes have occurred, metrics of the specification and/or visual simulation may be modified by transforming the data and specifically the metrics of the specification and/or visual simulation. In some approaches, only the metadata that is impacted by the changes is transformed and output and/or stored in order to save processing potential and reduce the amount of computer processing that is otherwise performed.

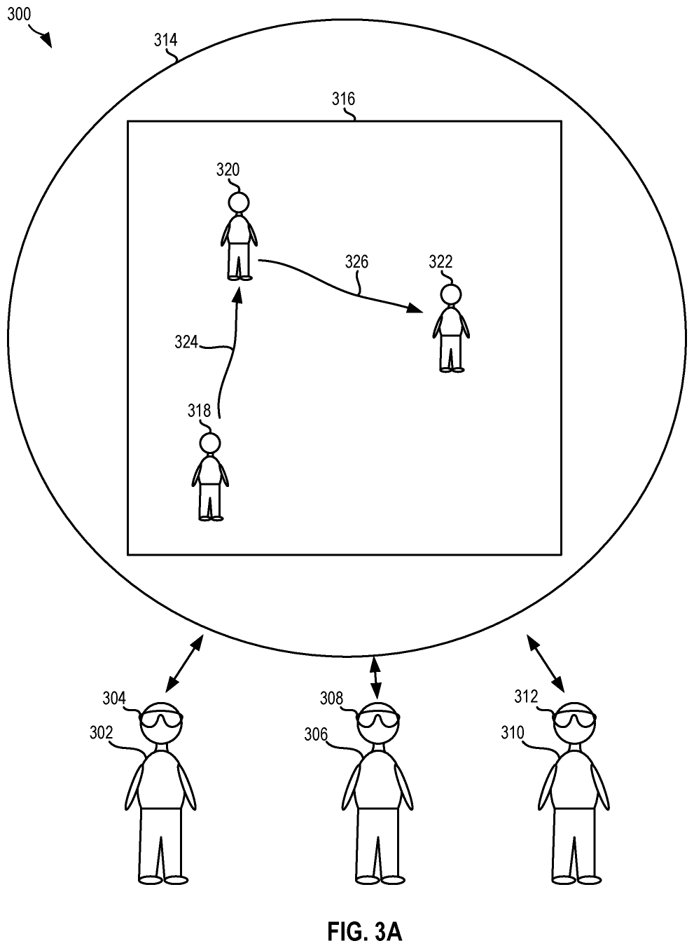

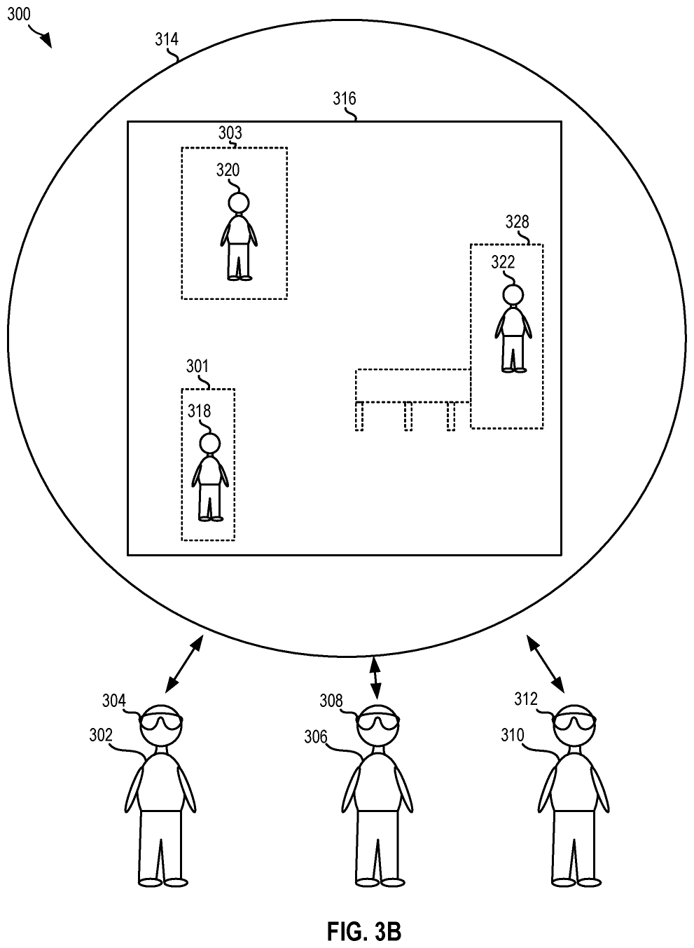

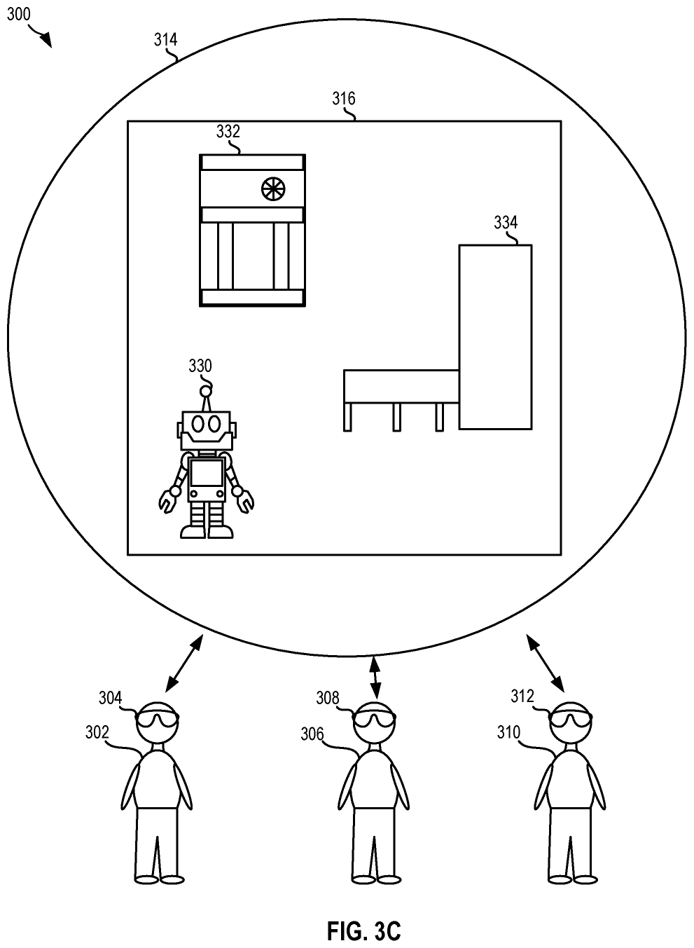

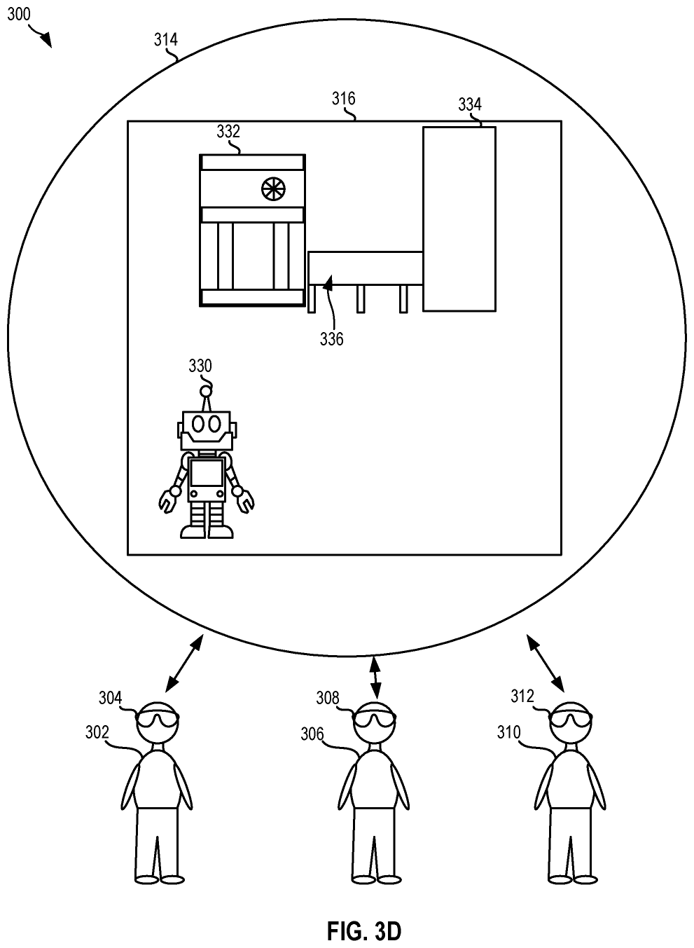

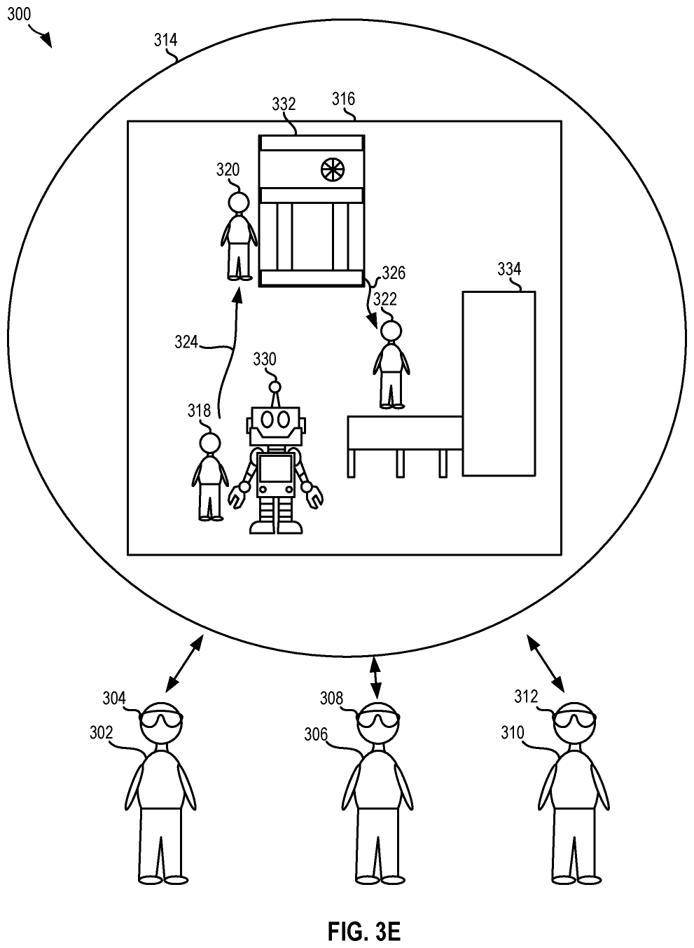

FIGS. 3A-3E depict an environment 300, in accordance with several embodiments. As an option, the present environment 300 may be implemented in conjunction with features from any other embodiment listed herein, such as those described with reference to the other FIGS. Of course, however, such environment 300 and others presented herein may be used in various applications and/or in permutations which may or may not be specifically described in the illustrative embodiments listed herein. Further, the environment 300 presented herein may be used in any desired environment.

The environment 300 includes a plurality of users wearing VR devices, e.g., see first user 302 wearing a VR headset 304, second user 306 wearing a VR headset 308 and third user 310 wearing a VR headset 312. Note that although only three users are shown in the current embodiment, in some other embodiments the environment 300 may include any number of users.

Referring first to FIG. 3A, a VR environment 314 that is based on an industrial floor 316 is created. A plurality of avatars associated with the users are created and added to the VR environment. For example, a first avatar 318 that is associated with the first user is created, a second avatar 320 that is associated with the second user is created, and a third avatar 322 that is associated with the third user is created. The activity of the users may, in some approaches, be identified by the VR devices based on mobility, hand and body gesture analysis, etc., and may be relayed to the behavior of the avatars depicted in the VR environment.

A first gamification role based on a first industrial task of the industrial floor may be assigned to the VR device worn by the first user. For purposes of an example, the first gamification role may be planning the location within the industrial floor for a robot that performs the first industrial task. A second gamification role based on a second industrial task of the industrial floor may be assigned to the VR device worn by the second user. For purposes of an example, the second gamification role may be planning a location within the industrial floor for a shaping machine that performs a second industrial task to an output of the robot that performs the first industrial task, e.g., see first industrial process flow 324. A third gamification role based on a third industrial task of the industrial floor may be assigned to the VR device worn by the third user. For purposes of an example, the third gamification role may be planning a location within the industrial floor for a lathe machine that performs a third industrial task to an output of the shaping machine that performs the second industrial task, e.g., see second industrial process flow 326. Gamification role data may be received from each of the VR devices. This data may be used to determine a specification for deploying on a physical industrial floor. In other words, the context of the roleplay gamification within the VR environment is analyzed to derive automation requirements of the industrial machines.

In some approaches, functionalities and capabilities of the industrial machines may be output to and displayed on the VR devices of a VR device that is currently assigned an associated gamification role.

In some approaches, the participating users may define a start and an end time of any given role and can change or exchange the role with one or more other users. For example, in some approaches, in response to receiving a request to make such exchanges, the assigned roles may be modified. Accordingly, in some approaches, a predetermined type of VR gamification analysis engine may be caused to analyze the changes and may adapt the same in the automation requirement gathering process.

Referring now to FIG. 3B, the avatars of the VR environment are shown to include floor spatial contours of industrial machines that perform the industrial tasks. The contours are positioned around the avatars that resemble the users. For example, contour 301 illustrates a spatial contour of the robot that performs the first industrial task, contour 303 illustrates a spatial contour of the shaping machine that performs the second industrial task, and contour 328 illustrates a spatial contour of the lathe machine that performs the third industrial task.

Referring now to FIG. 3C, the avatars of the VR environment are shown to be actual depictions of the industrial machines that perform the industrial tasks. For example, avatar 330 depicts the robot that performs the first industrial task, avatar 332 depicts the shaping machine that performs the second industrial task, and avatar 334 depicts the lathe machine that performs the third industrial task. The avatars may be moved about the industrial floor of the VR environment according to and in response to receiving user input on the VR devices. For example, referring now to FIG. 3D, the avatars are moved about the industrial floor of the VR environment from the positions that they are in in FIG. 3C. With continued reference to FIG. 3D, this movement may be made to position and consider an input of a conveyer belt portion 336 of the lathe machine depicted by the avatar 334 being fed by an output of the shaping machine depicted by the avatar 332.

Referring now to FIG. 3E, the avatars associated with the users are shown proximate to the actual depictions of the industrial machines that perform the industrial tasks. In some other approaches, the actual depictions of the industrial machines may be overlayed as a hologram over the avatars associated with the users.

It will be clear that the various features of the foregoing systems and/or methodologies may be combined in any way, creating a plurality of combinations from the descriptions presented above.

It will be further appreciated that embodiments of the present disclosure may be provided in the form of a service deployed on behalf of a customer to offer service on demand.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
creating a virtual reality (VR) environment that is based on an industrial floor;
providing, to at least a first VR device associated with a first user and a second VR device associated with a second user, access to the VR environment;
assigning a first gamification role to the first VR device, wherein the first gamification role is based on a first industrial task of the industrial floor;
assigning a second gamification role to the second VR device, wherein the second gamification role is based on a second industrial task of the industrial floor;
receiving gamification role data from the VR devices; and
determining and storing, based on the gamification role data, a specification for deploying in a physical industrial floor.

2. The computer-implemented method of claim 1, wherein the first industrial task is based on a first industrial machine's contribution to a predetermined industrial process within the industrial floor, wherein the second industrial task is based on a second industrial machine's contribution to the predetermined industrial process.

3. The computer-implemented method of claim 2, further comprising: generating, based on the determined specification, a visual simulation of the predetermined industrial process performed by the industrial machines; and outputting the visual simulation for display on the VR devices.

4. The computer-implemented method of claim 2, wherein the specification includes information that details a plurality of related operational timing sequences of the industrial machines, wherein the related operational timing sequences are based on contributions of the industrial machines with respect to the predetermined industrial process.

5. The computer-implemented method of claim 1, further comprising: adding avatars to the VR environment, wherein each of the avatars is associated with a different one of the VR devices.

6. The computer-implemented method of claim 5, wherein the avatars are generated based on factors selected from the group consisting of: physical appearances of the users, timing sequences of industrial machines of a predetermined industrial process within the industrial floor, and spatial dimensions associated with the industrial machines.

7. The computer-implemented method of claim 1, wherein the VR environment is implemented in a trusted execution environment (TEE), wherein the TEE is a secure container.

8. A computer program product, the computer program product comprising a computer readable storage medium having program instructions embodied therewith, the program instructions readable and/or executable by a computer to cause the computer to:
create a virtual reality (VR) environment that is based on an industrial floor;
provide, to at least a first VR device associated with a first user and a second VR device associated with a second user, access to the VR environment;
assign a first gamification role to the first VR device, wherein the first gamification role is based on a first industrial task of the industrial floor;
assign a second gamification role to the second VR device, wherein the second gamification role is based on a second industrial task of the industrial floor;
receive gamification role data from the VR devices; and
determine and store, based on the gamification role data, a specification for deploying on a physical industrial floor.

9. The computer program product of claim 8, wherein the first industrial task is based on a first industrial machine's contribution to a predetermined industrial process within the industrial floor, wherein the second industrial task is based on a second industrial machine's contribution to the predetermined industrial process.

10. The computer program product of claim 9, the program instructions further readable and/or executable by the computer to cause the computer to: generate, based on the determined specification, a visual simulation of the predetermined industrial process performed by the industrial machines; and output the visual simulation for display on the VR devices.

11. The computer program product of claim 9, wherein the specification includes information that details a plurality of related operational timing sequences of the industrial machines, wherein the related operational timing sequences are based on contributions of the industrial machines with respect to the predetermined industrial process.

12. The computer program product of claim 8, the program instructions further readable and/or executable by the computer to cause the computer to: add avatars to the VR environment, wherein each of the avatars is associated with a different one of the VR devices.

13. The computer program product of claim 12, wherein the avatars are generated based on factors selected from the group consisting of: physical appearances of the users, timing sequences of industrial machines of a predetermined industrial process within the industrial floor, and spatial dimensions associated with the industrial machines.

14. The computer program product of claim 8, wherein the VR environment is implemented in a trusted execution environment (TEE), wherein the TEE is a secure container.

15. A system, comprising:
a processor; and
logic integrated with the processor, executable by the processor, or integrated with and executable by the processor, the logic being configured to:
create a virtual reality (VR) environment that is based on an industrial floor;
provide, to at least a first VR device associated with a first user and a second VR device associated with a second user, access to the VR environment;
assign a first gamification role to the first VR device, wherein the first gamification role is based on a first industrial task of the industrial floor;
assign a second gamification role to the second VR device, wherein the second gamification role is based on a second industrial task of the industrial floor;
receive gamification role data from the VR devices; and
determine and store, based on the gamification role data, a specification for deploying on a physical industrial floor.

16. The system of claim 15, wherein the first industrial task is based on a first industrial machine's contribution to a predetermined industrial process within the industrial floor, wherein the second industrial task is based on a second industrial machine's contribution to the predetermined industrial process.

17. The system of claim 16, the logic further being configured to: generate, based on the determined specification, a visual simulation of the predetermined industrial process performed by the industrial machines; and output the visual simulation for display on the VR devices.

18. The system of claim 16, wherein the specification includes information that details a plurality of related operational timing sequences of the industrial machines, wherein the related operational timing sequences are based on contributions of the industrial machines with respect to the predetermined industrial process.

19. The system of claim 15, the logic further being configured to: add avatars to the VR environment, wherein each of the avatars is associated with a different one of the VR devices.

20. The system of claim 19, wherein the avatars are generated based on factors selected from the group consisting of: physical appearances of the users, timing sequences of industrial machines of a predetermined industrial process within the industrial floor, and spatial dimensions associated with the industrial machines.
